(19) United States
(12) Patent Application Publication
(10) Pub. No.: US 2013/0288801 A1
(43) Pub. Date: Oct. 31, 2013

(54) METHOD FOR CONDUCTING A VENUE-WIDE MULTIPLAYER GAME

(71) Applicant: AMI Entertainment Network, Inc., Bristol, PA (US)

(72) Inventors: William L. LAYNE, IV, Harleysville, PA (US); Augustus John RUSSO, Blue Bell, PA (US)

(21) Appl. No.: 13/828,848

(22) Filed: Mar. 14, 2013

Related U.S. Application Data
(60) Provisional application No. 61/616,233, filed on Mar. 27, 2012.

(51) Int. Cl. G07F 17/32

(52) U.S. Cl. CPC G07F 17/3225; G07F 17/323
USPC 463/42

(57) ABSTRACT

In a method of operating an on-demand multiplayer game system, a controller advertises availability of one or more on-demand multiplayer games to a plurality of individuals at a first venue. The controller receives a request from a first individual at the first venue to initiate a multiplayer game and outputs a notification of the initiation of the multiplayer game to one or more display units at the first venue. One or more additional individuals are allowed to join the multiplayer game. The multiplayer game is initiated with the first individual and the one or more additional individuals who joined the multiplayer game as participants.

### CROSS-REFERENCE TO RELATED APPLICATIONS

This application claims priority to U.S. Provisional Application No. 61/616,233, entitled “Method for Conducting a Venue-Wide Multiplayer Game,” currently pending, filed on Mar. 27, 2012, the entire contents of which are incorporated by reference herein.

### BACKGROUND OF THE INVENTION

Embodiments of the present invention relate generally to venue-based multiplayer games. More particularly, embodiments of the present invention are directed to a method and system for initiating and conducting on-demand multiplayer games using portable devices in an amusement device network.

Various electronic devices may be found at entertainment venues such as bars, restaurants, airports, shopping malls, video arcades, casinos, or the like. Such electronic devices include digital and analog televisions, projectors, computer displays, portable computing devices, tablet computing devices, digital jukeboxes and the like. The electronic devices typically are configured to output a plurality of content choices, such as electronic games, animations, videos and audio files. The game choices may include card games, sports games, games of skill, games of chance, action games, trivia games, or the like.

Each of the electronic devices may be utilized by the venue to provide programming or content to patrons of the venue. However, when the electronic devices are not being actively used by the patrons or the venue staff, they typically remain in an idle state. Previously, in the idle state, external programming, relevant information, advertisements or other passive entertainment games could be presented on the electronic devices. However, in the case of one-way devices such as televisions, patron interaction was limited to observing the content being displayed.

Accordingly, it is desirable to allow players to remotely interact with idle electronic devices deployed at a venue. It is further desirable to attract patrons' attention to the electronic devices and to increase patrons' enjoyment of and interactivity with the electronic devices at the venue by providing on demand multiplayer games. It is further desirable to allow the patrons to interact with the on demand multiplayer games using their portable devices, such as mobile phones.

### BRIEF SUMMARY OF THE INVENTION

In one embodiment, a method of operating an on-demand multiplayer game system is described. The method includes a controller advertising availability of one or more on-demand multiplayer games to a plurality of individuals at a first venue. The controller receives a request from a first individual at the first venue to initiate a multiplayer game and outputs a notification of the initiation of the multiplayer game to one or more display units at the first venue. One or more additional individuals at the first venue are allowed to join the multiplayer game. The multiplayer game is initiated with the first individual and the one or more additional individuals who joined the multiplayer game as participants.

In another embodiment, a method of operating a multiplayer game system is described. The method includes a controller outputting a notification that a multiplayer game is to begin to one or more display units at the first venue. Two or more individuals at the first venue are allowed to join the multiplayer game and the multiplayer game is initiated with the two or more individuals who joined the multiplayer game as participants.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1a is a sequence diagram of steps for initiating and joining an on-demand multiplayer game session in accordance with a preferred embodiment of the invention;

FIG. 1b is a sequence diagram of steps for initiating and joining an on-demand multiplayer game session in accordance with a second embodiment of the invention;

FIG. 2 is a flowchart of steps for initiating an on-demand multiplayer game session in accordance with the preferred embodiment of the invention;

FIG. 3a is a sequence diagram of steps for conducting an initiated on-demand multiplayer game in accordance with the preferred embodiment of the invention;

FIG. 3b is a sequence diagram of steps for conducting an initiated on-demand multiplayer game in accordance with the second embodiment of the invention;

FIG. 4 is a flowchart of an exemplary operation of a controller between an idle mode and an active mode;

FIG. 5 is an exemplary graphical user interface for starting and joining a multiplayer game in accordance with the preferred embodiment of the invention;

FIG. 6 is an exemplary display screen inviting individuals to join an initiated on-demand multiplayer game in accordance with the preferred embodiment of the invention;

FIG. 7a is an exemplary graphical user interface for inviting and joining a multiplayer game on a mobile device in accordance with the preferred embodiment of the invention;

FIG. 7b is an exemplary graphical user interface for an individual who has joined an initiated on-demand multiplayer game on a mobile device in accordance with the preferred embodiment of the invention;

FIG. 8 is an exemplary graphical user interface for playing a microgame on a mobile device in accordance with the preferred embodiment of the invention;

FIG. 9a is a schematic block diagram of various configurations of an amusement device system in accordance with certain preferred embodiments of the present invention;

FIG. 9b is a schematic block diagram of a gaming location having a local server in accordance with a preferred embodiment of the present invention;

FIG. 10a is an exemplary screenshot of a leaderboard for display in connection with the multiplayer game in accordance with certain preferred embodiments of the present invention;

FIG. 10b is an exemplary screenshot of a leaderboard sorted by device type for display in connection with the multiplayer game in accordance with certain preferred embodiments of the present invention;

FIG. 10c is an exemplary screenshot of a scoreboard combining scores for players using different device types for display in connection with the multiplayer game in accordance with certain preferred embodiments of the present invention; and

FIG. 10d is an exemplary screenshot of a report showing answers provided by participants using different device types during a multiplayer game in accordance with certain preferred embodiments of the present invention.

### DETAILED DESCRIPTION OF THE INVENTION

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

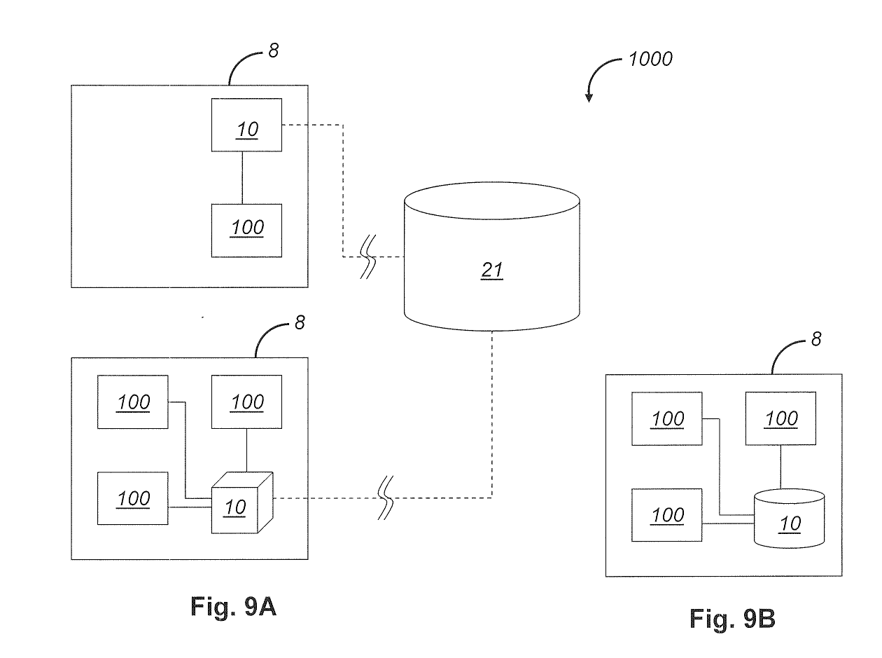

Electronic devices deployed at a venue allow the venue operator to provide entertainment to venue patrons and to increase profitability of the venue through interaction with the electronic devices. Referring to the drawings in detail, wherein like reference numerals indicate like elements throughout, as shown in FIG. 9a, at least a subset of the electronic devices 100 deployed at each venue are networked or connected with a controller 10. The network may be a Local Area Network (LAN) or Wide Area Network (WAN), and the electronic devices 100 may be connected to the network by one or more network cables, or wirelessly by, for example, an IEEE 802.11 WiFi connection.

The controller 10 is preferably a computing device located at, or near, the venue at which the electronic devices 100 are deployed. The controller 10 is connected to a central server 21 that interconnects controllers 10 deployed at multiple venues. In an alternate embodiment, as shown in FIG. 9b, the controller 10 may operate as a standalone device. The controller 10 preferably includes a plurality of input/output ports for connecting the controller 10 to one or more display devices. In one embodiment, the input/output ports are HDMI ports. The controller 10 includes a wired or wireless network interface (not shown) for connecting the controller 10 to a network. One or more storage devices, including random access memory and mass storage such as hard disk drives, flash drives, optical drives, or the like are included in or otherwise connected to the controller 10. The mass storage device (not shown) stores an operating system and software for controlling the operation of controller 10. Preferably, the mass storage device stores content that may be output to the electronic devices 100.

The operating software of the controller 10 preferably provides a graphical user interface (“GUI”) for use by venue staff and/or management to control content displayed on electronic devices 100 that are operatively coupled to the controller 10. For example, the GUI allows the venue staff to control power, volume and content being presented on any televisions operatively coupled to the input/output ports of the controller 10. Thus, the GUI may be used by venue staff to, for example, change the channels of one or more of the televisions. Preferably, the GUI of controller 10 is displayed on a tablet computer or other computing device with a touchscreen interface and is positioned such that it is only accessible to authorized individuals. However, any other display and input/output devices, such as flat screen monitors, keyboards and mice, may be used without departing from the scope of this invention.

The graphical user interface provided by the controller 10 also allows venue staff to create and distribute venue-specific content. For example, a venue can introduce a special offer for specific menu food items. Once the special offer is created, the controller 10 transmits the special offer for display on the one or more electronic devices 100 at the venue. Special offers may be created on-demand, or they may be pre-stored in memory of the controller 10 and scheduled to be displayed. Thus, if a venue is known to have a special offer on a food item every Thursday between the hours of 6 pm and 9 pm, the controller 10 can be programmed to display the special offer on the electronic devices 100 at the venue each week during this time. While in one embodiment, only the televisions at the venue display such venue-generated content, in other embodiments, other electronic devices 100 (e.g., electronic jukeboxes and currency operated amusement devices) may also display the same venue-generated content.

The controller 10 may also be used to initiate venue-specific or cross-venue multiplayer games. One such multiplayer game is a trivia game known as pub quiz. Typically, in a pub quiz game, a quiz master asks questions that teams of patrons answer on a sheet of paper. At the end of each round, the sheets of answers are submitted and the team scores are tabulated and announced by the quiz master. Such a pub quiz game is typically scheduled ahead of time and repeats on a weekly basis. However, this type of game suffers from multiple drawbacks. First, it takes the quiz master a substantial amount of time to tabulate the results and scores, resulting in lengthy delays. Second, it is difficult to track performance of a team across multiple events. Third, because a quiz master is required to be present, it is difficult to initiate an impromptu game.

Using the controller 10 and the electronic devices 100 deployed at the venue, venue-wide or cross-venue multiplayer games can be facilitated. The venue-wide or cross-venue multiplayer games can be pre-scheduled to occur at specific times, or they may be requested to be initiated on-demand by venue patrons or staff. When the multiplayer games are pre-scheduled, the controller 10 outputs a notification that a multiplayer game is set to begin at a particular time, and optionally starts a countdown timer prior to that time. The notification is displayed to venue patrons on the electronic devices 100 that are deployed at the venue. In order to join the multiplayer game, a patron must have access to an electronic device 100 capable of communicating with the controller 10. Examples of such electronic devices 100 include a mobile phone, a tablet computer, a netbook or laptop, a currency operated amusement device, or any other electronic device 100 having an input interface for electronically providing responses to the game content and an output interface for transmitting the responses to the controller 10.

When no venue-specified content (e.g., a prescheduled game or special offer) is being presented on the electronic devices 100, and there is no ether user interaction with the electronic devices 100, the controller 10 preferably places the electronic devices 100 into an idle state. Preferably, in the idle state, relevant, entertaining and/or educational content is displayed on the electronic devices 100. For example, the content may be special offers, advertisements, sports scores, weather information, financial information, news stories, microgames, or any other types of relevant content. Where the electronic device 100 is a television, the content described above may be overlaid over content presented on a broadcast or cable TV channel. In other embodiments, the electronic devices 100 may be placed into an energy conservation mode, such as sleep mode.

When the electronic devices 100 are in the idle mode, venue patrons are invited to initiate and/or join an on-demand multiplayer game. Multiplayer games may be venue specific or cross-venue. Available multiplayer games include, but are not limited to, trivia games, quiz games, word games, spot the difference games, card games (e.g.. poker), and the like. Thus, a variety of games may be adapted for use in such a multiplayer game system.

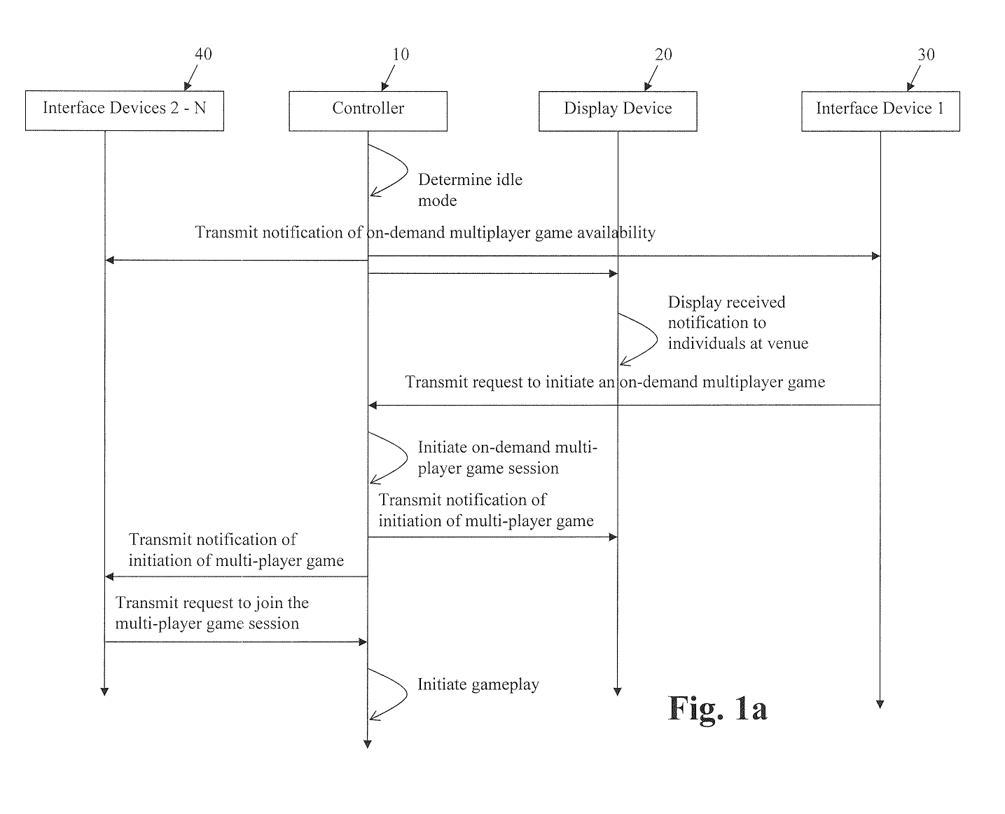

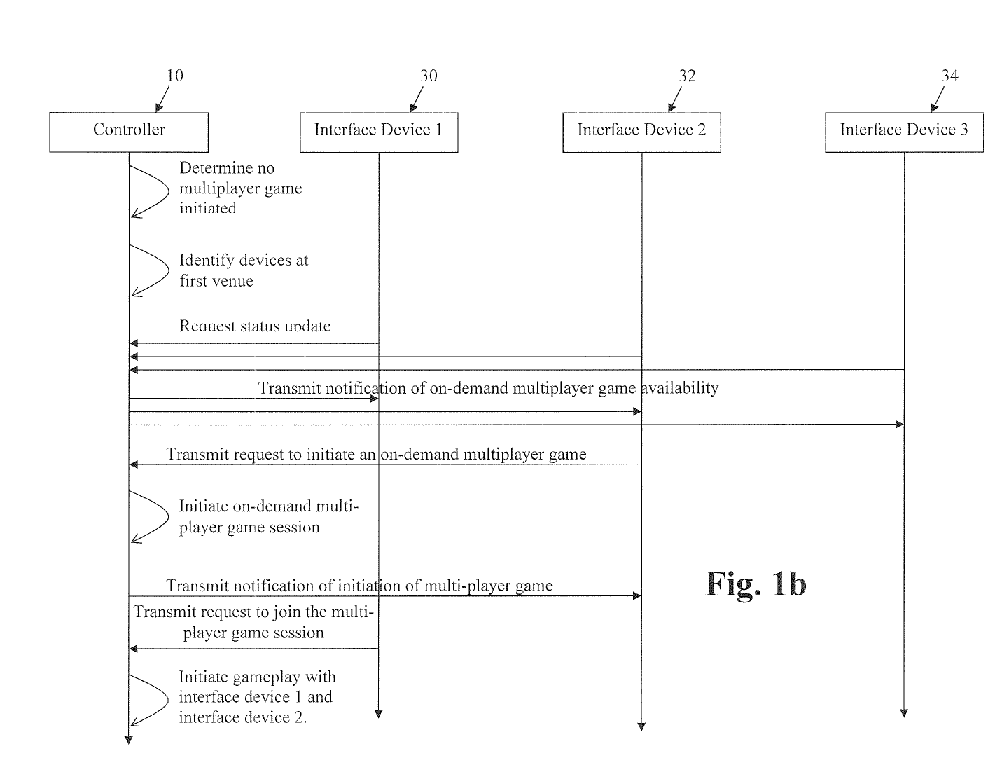

FIG. 1a is a sequence diagram of steps for initiating and joining an on-demand multiplayer game session in accordance with a preferred embodiment of the invention. The controller 10 determines that one or more of the electronic devices 100 are in an idle mode by determining that no pre-scheduled content is being presented and that an on-demand multiplayer game is not already in progress. In response to this determination, the controller 10 optionally outputs a notification, which is displayed on a display device 20, that an on-demand multiplayer game may be initiated. The display device 20 presents the notification by displaying a message, graphic, animation, or the like.

The notification notifies patrons of the venue that an on-demand multiplayer game may be initiated and can be presented together with other content, for example, by overlaying the notification. In addition, each of the interface devices 1-N 30, 40 can determine that an on-demand multiplayer game may be initiated by communicating with the controller 10. The interface devices 1-N 30, 40 are preferably devices that are located at the venue controlled by the controller 10. In one embodiment, the presence of an interface device at the venue can be determined by patrons using the respective interface devices to “check in” at the venue.

Preferably, each of the interface devices 1-N 30, 40 communicates with the controller 10 over a network via a wireless interface such as BLUETOOTH or WiFi 802.11. Alternatively, the interface devices 1-N 30, 40 may communicate with the controller 10 over a cellular or other

Internet connection by directly connecting to an IP address of the controller 10 or indirectly connecting with a central server (not shown) that is in communication with the controller 10. In the preferred embodiment, each of the Interface Devices 1-N 30, 40 is a portable computing device having an operating system. In one embodiment, a web (e.g., browser-based) interface can be utilized for the communication with the controller 10 by providing a web page for facilitating the communication. In another embodiment, an application for communicating with the controller 10 may be installed on the interface devices 1-N 30, 40 to facilitate the communication. Such applications may be downloaded from an application store such as the APPLE ITUNES APP STORE or the ANDROID APP STORE.

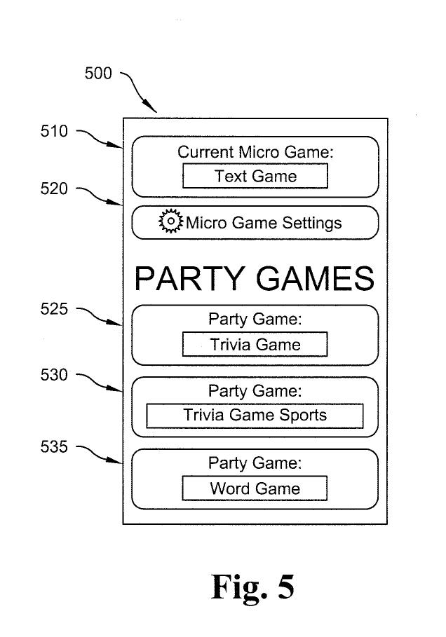

When a patron decides to initiate an on-demand multiplayer game, he selects one of the available games using a selection GUI (FIG. 5) displayed on the interface device 30. The interface device 30 transmits a request to initiate an on-demand multiplayer game to the controller 10, which initiates a game session for the requested game. Preferably, at this point, the other interface devices 2-N 40 are prevented from selecting a different multiplayer game to initiate.

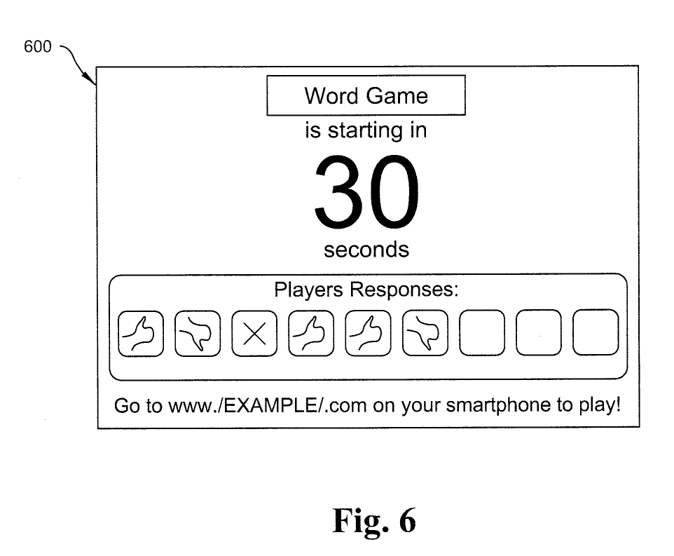

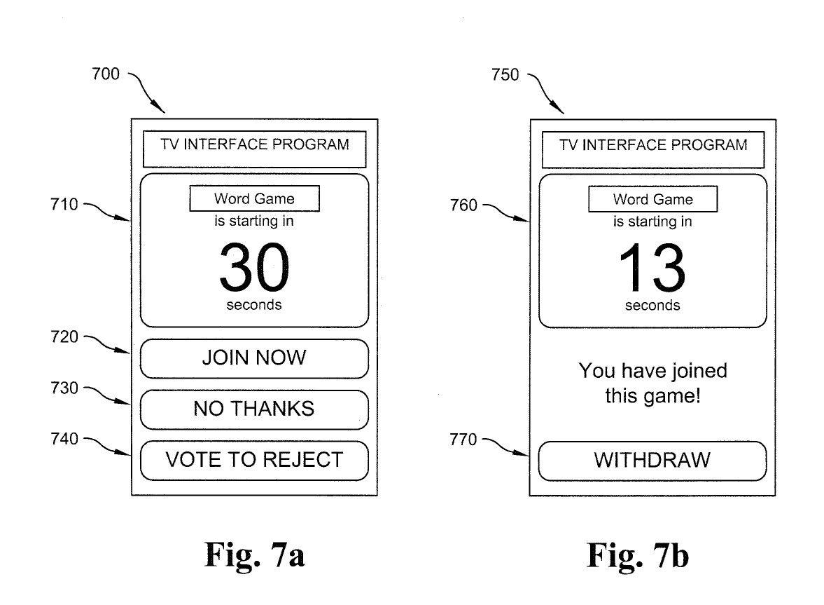

Once the game is initiated, patrons at the venue are invited to join the initiated game by the controller 10 transmitting a notification of the initiation of the multiplayer game to the respective interface devices 2-N 40 and/or to the display device 20. Patrons are optionally invited to join the initiated multiplayer game by, for example, displaying a display screen (FIG. 6) on one or more display devices 20, and they may join the initiated multiplayer game using a Join GUI (FIG. 7a) displayed by their respective interface devices 2-N 40.

While in one embodiment, the multiplayer games are venue specific, in other embodiments multiplayer games may be initiated across multiple venues. In this embodiment, patrons at other participating venues are also invited to join the initiated multiplayer game. In the case of a cross-venue multiplayer game, the controller 10 may communicate with similar controllers deployed at the additional venues to synchronize game initiation, play and scoring. In another embodiment, the controller 10 may be a central controller that controls multiple venues.

Regardless whether the game is venue specific or cross-venue, the interface devices 2-N 40 and the display device(s) 20 notify patrons that a multiplayer game has been initiated, and display an amount of time remaining for patrons to join the initiated game. In alternate embodiments, where a limited number of players are required, instead of a countdown to the start of the game, the controller 10 may display the number of joined players and wait for the requisite number of players to join the initiated game. Patrons join an initiated game using their respective interface devices 2-N 40.

For certain multiplayer games, once the countdown timer expires, it may be necessary to determine if a sufficient number of players have joined. If there are not a sufficient number of players, the game may be cancelled, in which case the controller 10 is placed back into the idle mode. Alternatively, the time to join may be extended to allow additional players to join the game. Assuming a sufficient number of players have joined, the controller 10 initiates gameplay of the multiplayer game. Preferably, such a game lasts approximately five minutes, however games may be shorter or longer, based on the game settings and the responsiveness of the players.

Referring now to FIG. 1b, a sequence diagram of steps for initiating and joining an on-demand multiplayer game session in accordance with a second embodiment of this invention is shown. The second embodiment is similar to the first embodiment, but a display device 20 is not utilized for any communications relating to the multiplayer games. In this case, the controller 10 determines that no multiplayer game is currently initiated at the venue and allows patrons to initiate a new multiplayer game using their respective interface devices. In a preferred embodiment, the controller 10 identifies devices associated with patrons of the venue by, for example, determining which devices have checked in to the venue. Thereafter, a notification of on-demand multiplayer game availability is transmitted to each such device. Preferably, the notification is transmitted in response to the respective interface device(s) querying the controller 10 for a status update. However, in alternate embodiments, the controller 10 may push updates to the interface devices 30, 32, 34.

As discussed above, a patron initiates a new multiplayer game using a graphical user interface displayed on the second interface device 32. In response to the selection, the second interface device 32 transmits a request to initiate an on-demand multiplayer game to the controller 10. The controller 10 initiates the game session in response to receiving the request and notifies the other interface devices (e.g., the first interface device 30 and the third interface device 34) checked in at the venue of the initiation of the multi-player game. One or more of the other interface devices (e.g., the first interface device 30) transmits a request to join the initiated multi-player game in response to receiving an input from the patron associated with the respective interface device. Once the requisite time to join the game has expired or the number of required players have joined, the controller 10 initiates game play with the joined interface devices (e.g., the first and second interface devices 30, 32) as participants.

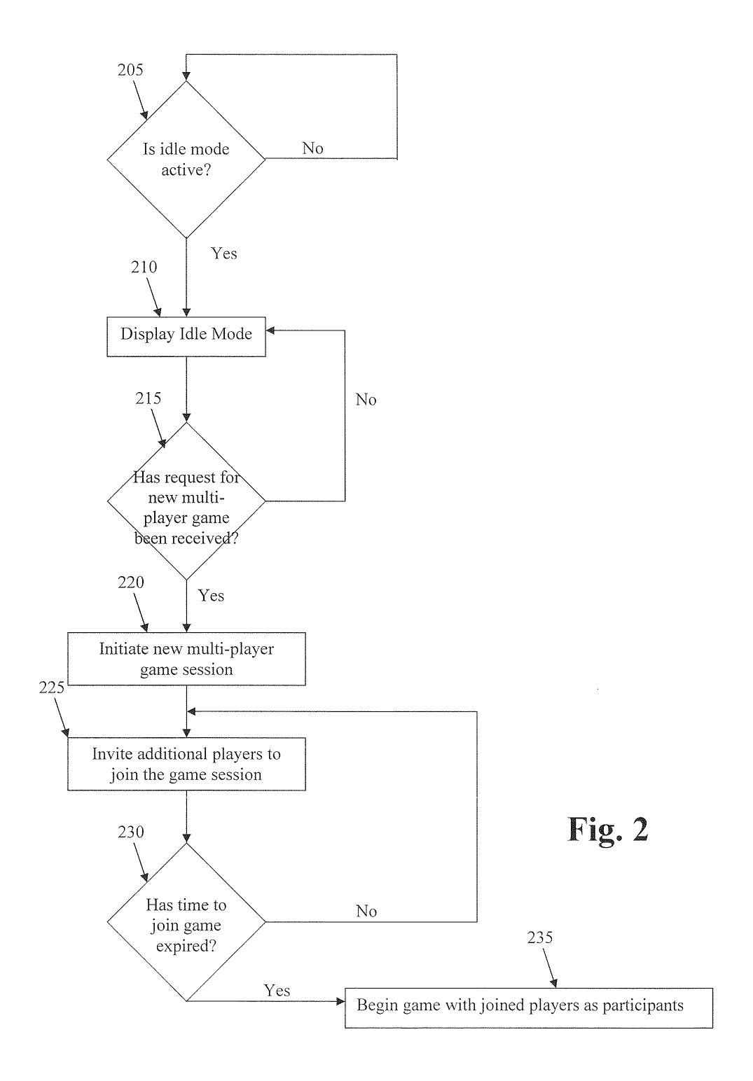

Referring to FIG. 2, a flowchart of steps for initiating an on-demand multiplayer game session is shown. The steps are preferably performed by the controller 10. At step 205, the controller 10 determines whether an idle mode is currently active. That is, the controller 10 determines whether electronic devices 100 at the venue are currently presenting prescheduled content or a previously initiated on-demand game. If the controller 10 determines that the idle mode is not active, it waits until the content completes and the idle mode is initiated. Once the idle mode is active, at step 210, the controller 10 outputs content relating to the idle mode, as described above. Preferably, as part of the idle mode, the controller 10 outputs invitations to initiate a new on-demand multiplayer game. At step 215, the controller 10 waits for a request to initiate a new multi-player game to be received. While no new request is received, the controller 10 remains with content relating to the idle mode being displayed. When a request to initiate a new game is received, at step 220, the controller 10 initiates a new multi-player game session. At step 225, the controller 10 invites additional players to join the game session, as described above. At step 230, the controller 10 determines whether the requisite time to join the initiated game has expired. If the time has not expired, the controller 10 continues to wait for additional players to join by outputting information relating to the initiated game, such as the name and the amount of time remaining to join. Once the time has expired, the game begins with the joined players as participants at step 235. In another embodiment, at step 230, the controller 10 further determines whether a sufficient number of players have joined the game prior to beginning the game.

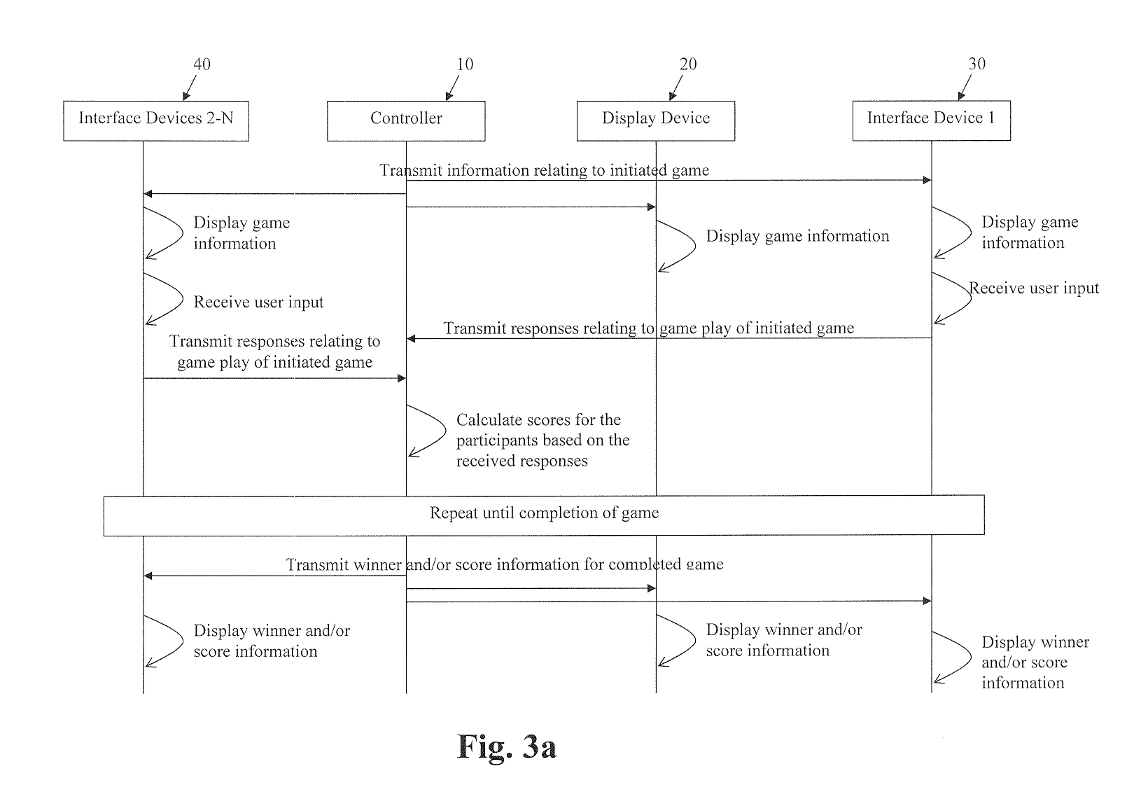

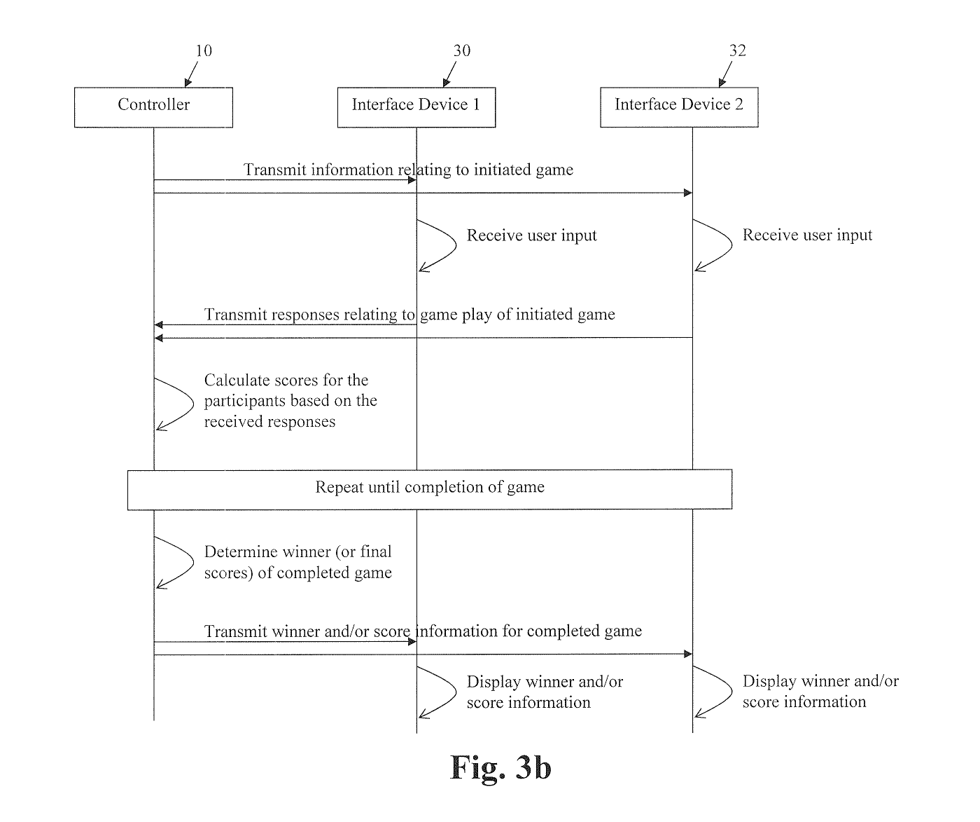

Once the multiplayer game begins, the participating patrons interact with the game using, their respective interface devices. Referring to FIG. 3a, the controller 10 outputs information relating to the initiated game to the display device 20 and the joined interface devices 1-N 30, 40. The display device 20 and the joined interface devices 1-N 30, 40 display the game information. Patrons use the interface devices 1-N 30, 40 to input responses to the displayed game information. The responses of the participating patrons are transmitted from the interface devices 1-N 30, 40 to the controller 10. The controller 10 calculates scores for the participants based on the received responses. The process of the controller 10 transmitting information relating to the game and receiving responses from the interface devices 1-N 30, 40 repeats until the game is completed.

Upon completion of the game, the final scores are calculated by the controller 10. Depending on the type of game selected, the controller 10 may determine a winner of the game instead of, or in addition to, calculating scores. The controller 10 outputs the scores and/or winner information to the participating interface devices 1-N 30, 40, where the information is displayed for the participating patrons. The scores and/or winner information may also be transmitted to the display device 20 so that other patrons of the venue who were not participating in the game can view the results.

In another embodiment, referring to FIG. 3b, a display device 20 is not utilized for game play of the multi-player game. In this case, only players participating in the initiated multi-player game through their respective interface devices are able to follow along with the game, and to view score and winner information. It should be noted that while in this embodiment, game information and score information is not displayed on the display device 20, the notifications and advertisements of the on-demand multiplayer game and the invitations to join an initiated game may still be presented on a display device 20, as shown in FIG. 1a. Thus, in this embodiment, the controller 10 communicates only with the participating interface devices (the first and second interface devices 30, 32) during game play. The remaining communications are similar to those described with respect to FIG. 3a and will not be described herein for sake of brevity.

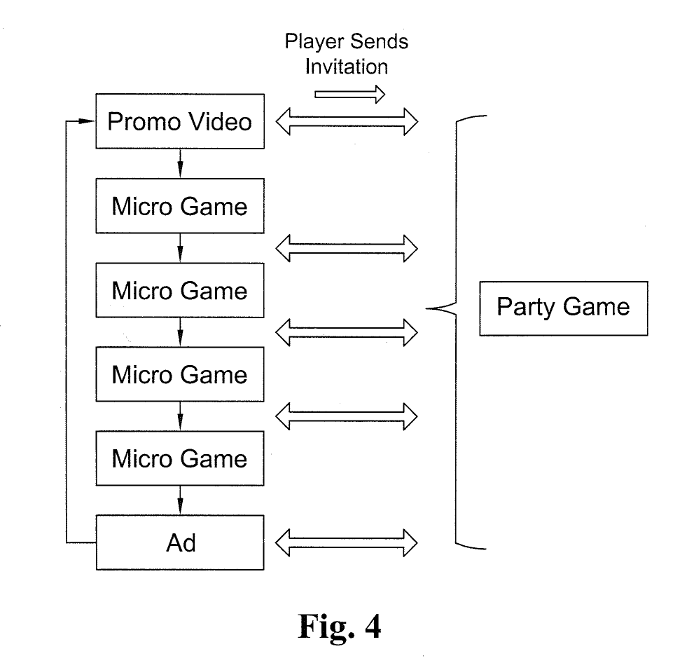

Referring now to FIG. 4, a flowchart of an exemplary operation of a controller 10 between an idle mode and an active mode is shown. The controller 10 outputs a promotional video. The promotional video can relate to any topic, but in a preferred embodiment, the video demonstrates the on-demand multiplayer game capability. Microgames may be presented to attract the attention of patrons. Microgames are preferably short (e.g., 30 second) games that patrons may participate in by responding in the appropriate fashion. For example, microgames may include trivia questions, hide a ball under the cup games, word games, and the like.

Generally, such microgames do not require players to actively join, but instead are asynchronous. That is, only those patrons that respond to the microgame are considered participants. Therefore, there is preferably no minimum number of players that are required for a microgame. In FIG. 4, two such microgames are played.

At any time during the idle sequence, a user can request an on-demand multiplayer game. Once the on-demand “party game” is requested, the controller 10 initiates a game session and begins a count down to initiate play. Following completion of the on-demand game, the controller 10 returns to the idle mode and in the example of FIG. 4, two additional microgames and an advertisement are displayed. While in the exemplary embodiment of FIG. 4, two microgames are shown before and after the on-demand “party game”, any other number and/or ordering of such content may be presented in the idle mode. That is, the ordering, quantity, and appearance of microgames in the idle mode is configurable. It should be noted that at any time after completion of the first on-demand game, a player could initiate a new on-demand game. Further, in the idle mode, the controller 10 can output other content. That is, the promo video, microgames and advertisement that are displayed by the controller 10 in FIG. 4 are exemplary and other content may be presented in any quantity and order, at any time while in the idle mode.

Referring now to FIGS. 5-8, various exemplary graphical user interfaces for interacting with the controller 10 are shown. FIG. 5 is an exemplary home screen GUI 500 for an interface device to interact with the controller 10. The home screen GUI 500 is designed to be presented on a portable device with a touchscreen, but other layouts and designs may be produced for other formats of devices without departing from the scope of the invention. The home screen GUI 500 includes a plurality of selectable buttons for interacting with microgames and initiating new on-demand “Party Games.” The Current microgame button 510 allows a patron to interact with the microgame being presented by the controller 10. The microgame Settings button 520 allows the patron to change settings for microgames. For example, a setting may allow automatically presenting the microgame GUI to the user without the user electing to interact with the microgame. Other settings allow controlling alerts made by the controller about microgames, such as vibrate or make sound when microgame starts or results are shown.

The home screen 500 includes a plurality of buttons for initiating an on-demand multiplayer game. In a preferred embodiment, the most popular games (e.g., Trivia Game 525, Trivia Sports 530 and Word Game 535) are displayed on the initial home screen GUI 500, while other games may be presented on additional screens (not shown). In an alternate embodiment, the home screen GUI 500 may present categories of games (e.g., trivia games, card games) on the home screen and the individual game selections on subsequent screens.

Referring to FIG. 6, once a patron has selected one of the on-demand games, the controller 10 outputs an invitation to join the game to the display device 20. An exemplary display screen 600 is shown in FIG. 6. As can be seen, the display screen 600 includes the name of the game being started and a countdown timer to the start of the game. Preferably, responses of other players to the invitation are also shown on the display screen 600. While the display screen 600 is shown in FIG. 6 as having both players who have accepted and denied the invitation, in other embodiments, only players who have accepted may be shown without departing from the scope of this invention. In addition, the display screen 600 may include information for joining the game, such as a URL of a website or a name of an application needed for participating in the game.

When a patron visits the URL or loads the application for participating in the game on their interface device, a Join GUI 700 (FIG. 7a) is presented to the patron. Similarly to the display screen 600, the Join GUI 700 includes an information window 710 showing a name of the initiated game and the countdown timer to the start of the game. A Join button 720 allows the patron to join the game. When the patron presses the Join button 720, an acceptance message is transmitted to the controller 10. An optional Deny button 730 is also included in the Join GUI 700. When the user presses this button, a denial message that the patron does not wish to participate in the game is transmitted to the controller 10. Finally, a Vote to Reject button 740 is provided. The Vote to Reject button 740 allows patrons to indicate that they are displeased with the initiated game selection. Thus, if a sufficient number of patrons select this button, the controller 10 may be programmed to cancel the selected game so that a different game may be chosen. Preferably, multiple patrons must select the Vote to Reject button 740 before the game is cancelled.

Once the patron has joined the game by pressing the Join button 720, a Wait GUI 750 (FIG. 7b) is displayed to the patron. The Wait GUI 750 includes an information window 760 that identifies the name of the joined game and the status of the countdown timer. A Withdraw button 770 allows the patron to leave the game. Leaving the game preferably returns the patron to the Join GUI 700 and transmits a message to the controller 10 indicating that the patron is no longer participating in the game.

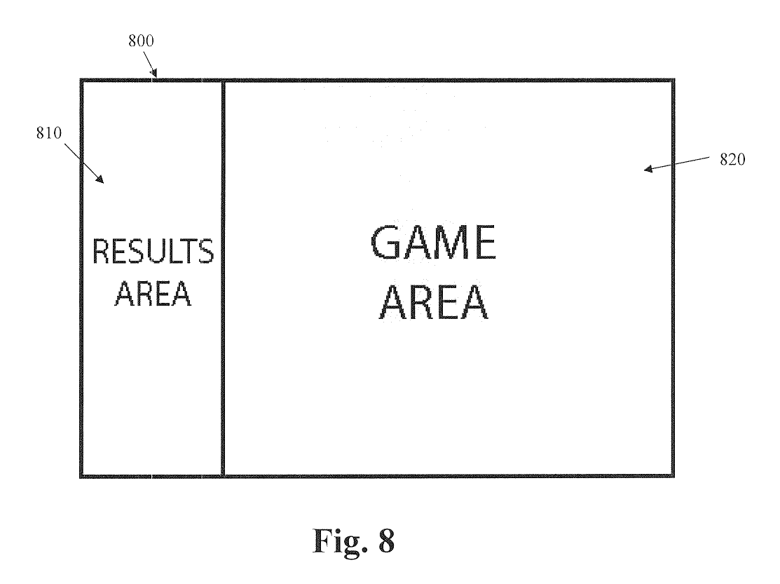

When the countdown timer runs out, the controller 10 begins the selected game, assuming a sufficient number of patrons have joined. Referring to FIG. 8, an exemplary microgame GUI 800 is shown. The Game GUI 800 includes a results area 810, which shows scores of participating patrons, and a game area 820 that includes information and graphics relevant to the microgame currently being presented. Thus, for example, if the microgame is a trivia game, the Game area 820 would include the current trivia question and selectable answer choices in response to the presented question. The results area 810 shows the results of participants in the microgame. For example, in the trivia game, the results area 810 may identify players who got the trivia question right or wrong.

In preferred embodiments of the present invention, the controller 10 may receive information about the interface devices 1-N 30, 40 so that results or leaders may be displayed in the results area with an emphasis on the type of device being used. That is, users or teams may be identified separately by use of, for example, IPHONES, ANDROID PHONES, WINDOWS PHONES, or the like.

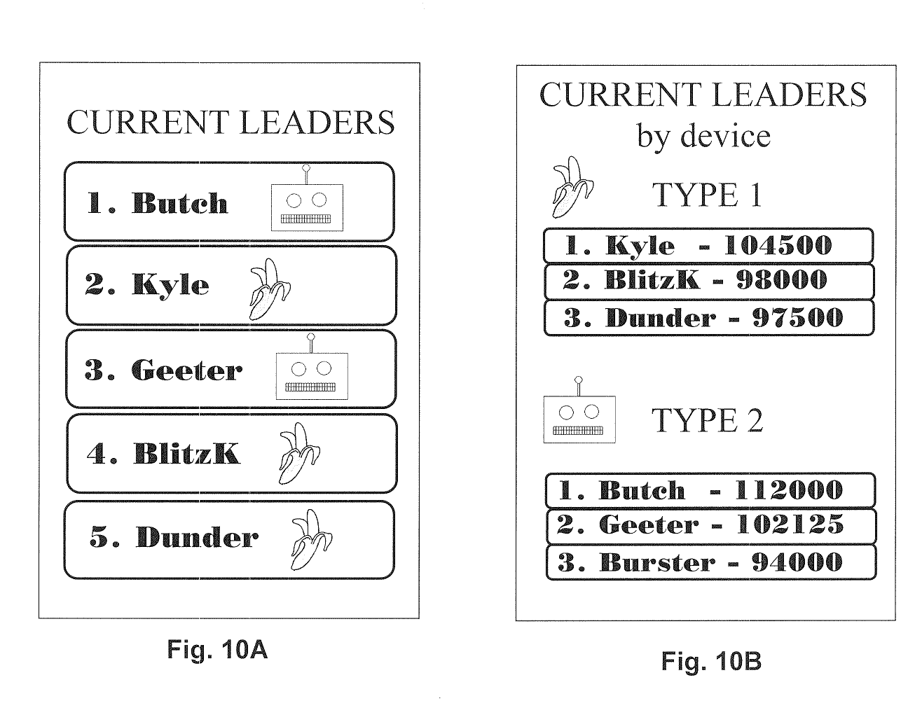

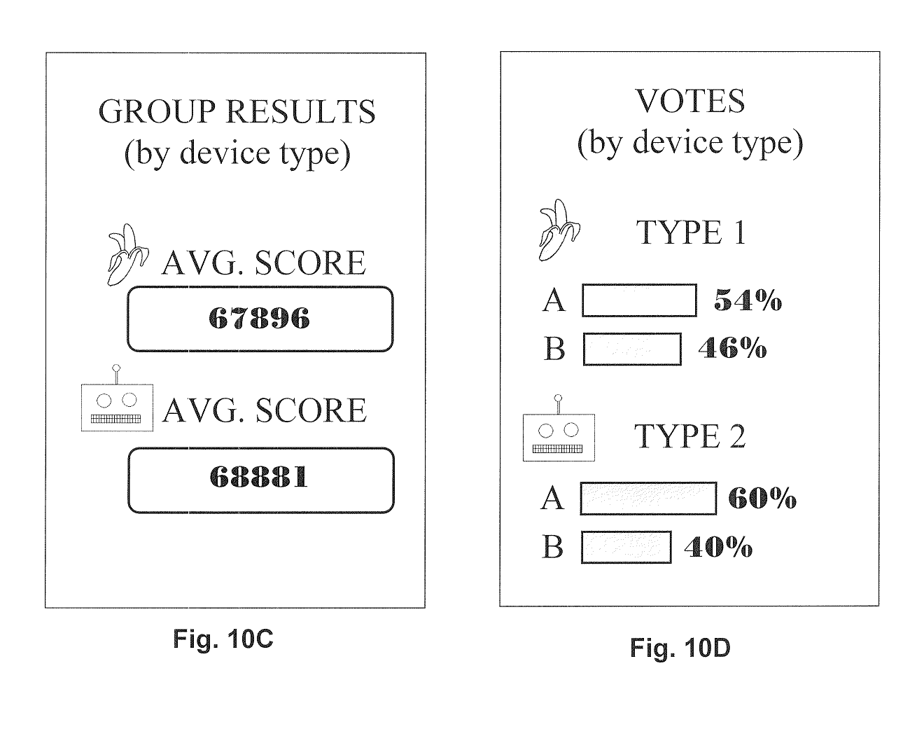

FIG. 10A is an exemplary screenshot of a combined leaderboard 1100 that may be displayed in the results area 810 (FIG. 8). The top player names 1105 may be ranked in order based on score, time, or the like as dictated by the rules of the game being played at the controller 10. Icons 1110 are used in FIG. 10A to provide information as to the type of device being used by each of the players listed on the leaderboard 1100. Although icons 1110 are shown, other methods such as text, symbols, or the like, may be used to provide the device information for the top player names 1105. Scores, times, or other information (not shown) may also be displayed on the leaderboard 1100.

FIG. 10B shows an exemplary screenshot of an alternative leaderboard 1200, wherein the top scores are separately listed by the type of device. For example, the top player names 1205 and scores 1215 are provided under a header 1210 for each type of device being used. The number of player names 1205 per device type, as well as the number of separate device types to list, may be adjusted as desired. For example, where the top six scores come from two different device types, scores from a third device type might not be shown. Again, additional information can also be displayed on the leaderboard 1200 as desired.

FIG. 10C shows an exemplary screenshot of a head-to-head competition 1300, wherein the scores from users are averaged according to device type. For example, an average score 1220 of all users of a first device type may be compared to an average score 1230 of all users of a second device type. This method, in effect, creates teams based on device type. Rather than being averaged, scores or times can also be combined or the like in a manner reflective of the relative skill in completing the game.

FIG. 10D shows an exemplary screenshot of a report 1400 wherein answers provided in response to a survey or trivia question are displayed by device type. For example, a breakdown of votes for answer “A” 1440 and answer “B” 1450 is shown for each device type.

It will be appreciated that the reports shown in FIGS. 10A-10D may be displayed in the results area 810 of the display device 20 or may be individually accessible on the interface devices 1-N 30, 40. In addition, the leaderboards shown in FIGS. 10A-10D may be adjustable by the users or an operator of the system to customize the display of results.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A method of operating an on-demand multiplayer game system, the method comprising:
advertising, by a controller, availability of one or more on-demand multiplayer games to a plurality of individuals at a first venue;
receiving, by the controller, a request from a first individual at the first venue to initiate a multiplayer game;
outputting, by the controller, a notification of the initiation of the multiplayer game to one or more display units at the first venue;
allowing one or more additional individuals at the first venue to join the multiplayer game; and
initiating the multiplayer game with the first individual and the one or more additional individuals who joined the multiplayer game as participants.

2. The method of claim 1, wherein the one or more display units are selected from the set comprising televisions, digital jukeboxes, amusement devices and mobile devices.

3. The method of claim 2, wherein at least one of the one or more display units is a television and the advertising is presented on a game channel displayed on the television.

4. The method of claim 1, further comprising:
receiving, by the controller, inputs relating to the initiated multiplayer game from computing devices associated with the participants.

5. The method of claim 4, further comprising:
maintaining, by the controller, a score for each of the participants for the initiated multiplayer game based on the received inputs.

6. A method of operating a multiplayer game system, the method comprising:
outputting, by a controller, a notification that a multiplayer game is to begin to one or more display units at the first venue;
allowing two or more individuals at the first venue to join the multiplayer game; and
initiating the multiplayer game with the two or more individuals who joined the multiplayer game as participants.

7. The method of claim 6, further comprising outputting, by the controller, a leaderboard providing an ordered listing of the participants having the highest or lowest scores in the multiplayer game.

8. The method of claim 7, wherein each of the participants uses a device of the first type or a device of the second type to play the multiplayer game.

9. The method of claim 8, wherein the controller divides the leaderboard into a first list of the participants using the device of the first type and a second list of the participants using the device of the second type.

10. The method of claim 8, further comprising combining, by the controller, scores from participants using the device of the first type, combining, by the controller, scores from participants using the device of the second type, and outputting, by the controller, the combined scores for the users of the device of the first and second types.

11. The method of claim 8, further comprising outputting, by the controller, an analysis of inputs during the multiplayer game from the participants using the device of the first type and an analysis of inputs during the multiplayer game from the participants using the device of the second type.

12. The method of claim 7, wherein the leaderboard is displayed on a separate area in the one or more display units from the multiplayer game.

13. The method of claim 7, wherein the controller, for each of the participants listed on the leaderboard, provides an indication on the one or more display units of a type of device used by the respective participant to play the multiplayer game.

14. The method of claim 6, wherein the outputting of the notification by the controller is preceded by receipt of an on-demand request from an individual at the first venue to initiate the multiplayer game.

15. The method of claim 6, wherein a time at which the multiplayer game is to begin is prescheduled.
